(19) United States
(12) Patent Application Publication
(10) Pub. No.: US 2023/0138086 A1
(43) Pub. Date: May 4, 2023

(54) DATA ANALYSIS SYSTEM AND COMPUTER PROGRAM

(71) Applicant: SHIMADZU CORPORATION, Kyoto (JP)

(72) Inventors: Yuichiro FUJITA, Kyoto (JP); Tomohiro KAWASE, Kyoto (JP)

(21) Appl. No.: 17/957,014

(22) Filed: Sep. 30, 2022

(30) Foreign Application Priority Data
Nov. 1, 2021 (JP) 2021-178815

(51) Int. Cl. G01N 30/86

(52) U.S. Cl. CPC G01N 30/86; G01N 2030/027

(57) ABSTRACT

A data storage part (2) that stores a plurality of analysis results obtained by a plurality of analyses performed under a plurality of analysis conditions and a plurality of parameters included in the analysis conditions, wherein each analysis result is factor and each analysis condition is response, and the response and the factor are associated with each other, a data processor (4) configured to perform operation using data stored in the data storage part (2), and a display (8) electrically connected to the data processor (4) are included. The data processor (4) is configured to create a regression model indicating a relationship of a variable with the response, by determining coefficients of each of terms constituting a predetermined model expression, in which the factor is the variable, based on the model expression by using a predetermined statistical analysis algorithm, and the data processor (4) is configured to create reliability information, which is able to be referred by a user on the display (8), by quantifying reliability of the regression model based on a relationship with the response.

### BACKGROUND OF THE INVENTION

### 1. Field of the Invention

The present invention relates to a data analysis system and a computer program for analyzing a relationship between an analysis condition and an analysis result obtained by performing analysis such as liquid chromatography analysis under a plurality of analysis conditions.

### 2. Description of the Related Art

When an analysis condition is examined in liquid chromatography analysis or the like, a relationship between each factor (in a case of chromatography analysis, temperature of a column, solvent concentration, and the like) of an analysis condition and a response (for example, in a case of chromatography analysis for the purpose of two-component separation, degree of separation between component peaks on a chromatogram, and the like) is converted into a two-dimensional graph (heat map or the like). There is also a data analysis system (software) that creates such a two-dimensional graph (see, for example, https://www.jmp.com/ja_jp/offers/doe-design-space.html).

A contour line connecting coordinate points at which a target response takes a specific value is displayed on a created two-dimensional graph, and it is easy to visually grasp an area in which the response is a specific value or more or less. Therefore, by using such a two-dimensional graph, it is easy to determine what kind of analysis condition should be selected to obtain the target response.

In order to draw the two-dimensional graph as described above, data indicating a relationship between each factor of an analysis condition and a response is necessary, but it is not realistic to actually measure responses for all coordinate points (combinations of factor parameters) on the two-dimensional graph. For example, assuming that there are ten stages (ten coordinate points) of parameters of each factor of an analysis condition, if there are three factors, it is necessary to perform 10³=1000 experiments to measure a response. For this reason, it is common to perform an experiment under an analysis condition of coordinate points much less than coordinate points on a two-dimensional graph, measure a response, create an equation called a regression model using the obtained measurement data, and associate a predicted value with remaining coordinate points that have not been subjected to an experiment, on the basis of the created regression model.

### SUMMARY OF THE INVENTION

As described above, a regression model is required to create a two-dimensional graph showing a relationship between a factor and a response. The regression model is created by determining a coefficient of each term of a model expression using a statistical analysis algorithm such as the least squares method on the basis of a model expression including a term whose coefficient is not yet determined. As described above, the regression model statistically predicts a relationship of each factor with a response, but it cannot be said that the prediction is absolutely reliable. For example, in a case where there are measurement data having a large variation and measurement data having a small variation, a regression model created using the measurement data may be the same equation. However, reliability of these regression models is not the same, and it can be said that the regression model created using the measurement data having a small variation has higher reliability. Further, if a structure of a model expression (a type and number of terms included in the model expression) used as the basis is not appropriate in the first place, a regression model is not accurately created. That is, reliability of a regression model depends on variation in a response of measurement data used for regression analysis, a model expression used as the basis, and the like.

However, in a data analysis system that has been used, the user cannot know information regarding reliability of a created regression model. For this reason, the user has not understood how much the user needs to trust information such as a two-dimensional graph indicated by a data analysis system to determine an analysis condition.

The present invention has been made in view of the above problem, and an object of the present invention is to enable the user to easily grasp reliability of a regression model.

A data analysis system according to the present invention includes a data storage part that stores a plurality of analysis results obtained by a plurality of analyses performed under a plurality of analysis conditions and a plurality of parameters included in the analysis conditions, wherein each analysis result is factor and each analysis condition is response, and the response and the factor are associated with each other, a data processor configured to perform operation using data stored in the data storage part, and a display electrically connected to the data processor. The data processor is configured to create a regression model indicating a relationship of a variable with the response, by determining coefficients of each of terms constituting a predetermined model expression, in which the factor is the variable, based on the model expression by using a predetermined statistical analysis algorithm, and the data processor is configured to create reliability information, which is able to be referred by a user, on the display by quantifying reliability of the regression model based on a relationship with the response.

In the data analysis system according to the present invention, the data processor quantifies reliability of a created regression model on the basis of a relationship with a response and creates reliability information that can be referred to by the user on the display, so that the user can easily grasp reliability of the regression model.

### BRIEF DESCRIPTION OF THE DRAWINGS

FIG. 1 is a block diagram illustrating an embodiment of a data processing system;

FIG. 2 is a flowchart illustrating an example of data analysis processing executed in the embodiment;

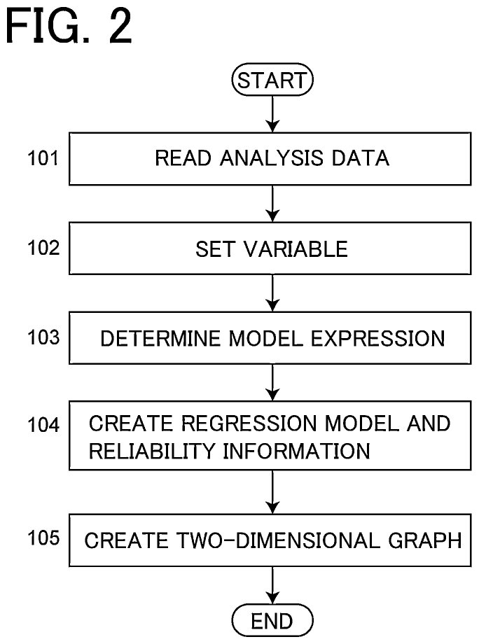

FIG. 3 is a diagram illustrating an example of a screen for displaying reliability information; and

FIG. 4 is an example of a two-dimensional graph created based on a regression model.

### DETAILED DESCRIPTION OF THE INVENTION

Hereinafter, an embodiment of a data analysis system will be described with reference to the drawings.

The data analysis system 1 is constructed by introducing a computer program into a computer device, and includes a data storage part 2, a data processor 4, an information input device 6, and a display 8.

The data storage part 2 is a storage area for storing analysis data obtained by an analysis device 100, and is realized by a partial area of an information storage device such as a hard disk drive. The analysis device 100 is, for example, a liquid chromatograph. The data processor 4 is a function realized by a central processor (CPU) executing a predetermined program.

The data processor 4 executes predetermined data analysis processing using analysis data stored in the data storage part 2. Processing executed by the data processor 4 will be described later. The information input device 6 and the display 8 are connected to the data processor 4. The information input device 6 is realized by a keyboard, a mouse, or the like, and the user can input information to the data processor 4 through the information input device 6. Information to be presented to the user is output from the data processor 4 to the display 8 as necessary, and is displayed on the display 8.

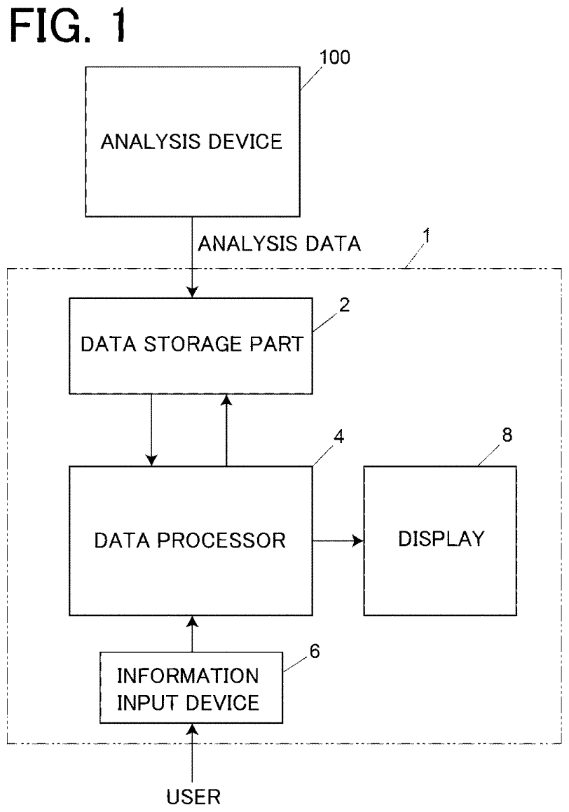

Data analysis processing executed by the data processor 4 will be described with reference to a flowchart of FIG. 1.

As the premise, the data storage part 2 stores a response (that is, a separation result such as the degree of separation of peaks in a chromatogram, the number of peaks, retention time of each peak, and the like) obtained by changing a plurality of factors (for example, a flow rate of a mobile phase, temperature of a column oven, composition of a mobile phase solvent, a mixing ratio of a mobile phase solvent, a gradient method, a sample injection amount, and the like) of an analysis condition and performing analysis for the same sample, the response being associated with each parameter of each analysis condition. The data processor 4 reads analysis data stored in the data storage part 2 (Step 101).

Next, the data processor 4 sets a factor to be a variable from among factors of the read analysis data (Step 102). The factor to be a variable may be set on the basis of information input by the user, or all the factors may be considered as variables. After the above, the data processor 4 determines a model expression to be a basis of a regression model (Step 103). The model expression is an expression including a sum of terms whose coefficient is not yet determined using a variable. A structure (that is, what kind of a term is included) of the model expression may be optionally set by the user, or an existing model expression may be used.

After determining a model expression, the arithmetic processor 4 determines a coefficient of each term of the model expression using a predetermined statistical analysis algorithm, and, by this, creates a regression model representing a relationship of each factor with a response (Step 104). Examples of the statistical analysis algorithm used to determine a coefficient of each term include the least squares method and Bayesian inference. The statistical analysis algorithm to be used may be optionally selected by the user.

Construction of a regression model by the least squares method is generally obtained by matrix calculation or optimization calculation. Several approaches are known for construction of a regression model by Bayesian inference, and a Markov chain Monte Carlo method (MCMC) is used as an easiest and most accurate method for estimation. Although details of an execution method of Bayesian inference using MCMC are omitted, as an outline, an approach to obtain distribution of the prediction values and parameter values is taken by evaluating how easily each value of each parameter is realized for observation data by trial and error using a random number. One of representative software libraries for executing Bayesian inference using MCMC is stan (https://mc-stan.org/), and Bayesian inference using this stan is also performed in the present embodiment.

Furthermore, the arithmetic processor 4 converts variation of values of each response to the created regression model by standard deviation or the like into a numerical value, and creates reliability information of the regression model using the numerical value (Step 104). The reliability information will be described later, but the user can refer to the reliability information created here.

After creating the regression model and the reliability information, the arithmetic processor 4 creates a two-dimensional graph that allows the user to easily visually grasp a relationship between a factor and a response on the basis of the created regression model (Step 105). In an example of the two-dimensional graph, a contour line having a predetermined response value is drawn on planar coordinates having a factor as a numerical axis.

Here, the arithmetic processor 4 may be configured to set a fluctuation width of a contour line using a numerical value of variation of values of each response to the regression model and display the fluctuation width on a two-dimensional graph. In this case, display of the fluctuation width of a contour line may be performed at all times or may be performed only when the user desires.

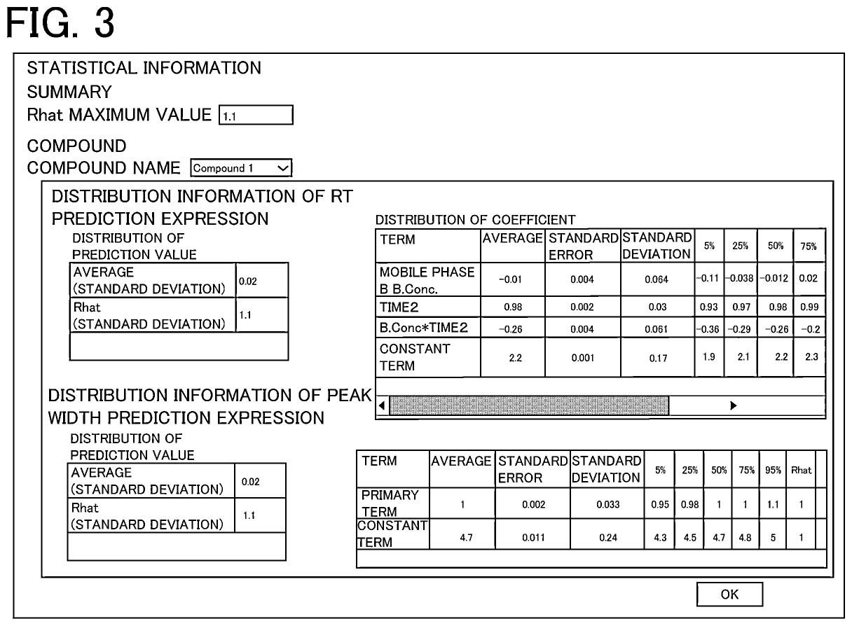

FIG. 3 is an example of a statistical information pane that displays reliability information of a regression model. This statistical information pane is one in a case where Bayesian inference is used as a statistical analysis algorithm. In this example, retention time (RT) and a peak width are set as responses, and statistical information of a regression model (RT prediction expression and peak width prediction expression) representing a relationship between a plurality of factors with respect to the responses is listed in a table.

In two upper and lower tables on the left side of the statistical information pane, a value “average (standard deviation)” indicating variation of values of a response to each of an RT prediction expression and a peak width prediction expression and a value “Rhat (standard deviation)” indicating appropriateness of a model expression on which the regression model is based are indicated as reliability information. In the present embodiment, it is assumed that “a response has normal distribution (mountain-shaped distribution), and an actually measured response is a value randomly sampled from the normal distribution” in Bayesian inference. At this time, a width of the normal distribution is expressed by standard deviation, and the larger the standard deviation, the wider the normal distribution (that is, estimation accuracy of a prediction value is poor), and the smaller the standard deviation, the narrower the width of the normal distribution (that is, prediction accuracy is excellent). As a result of constructing a regression model by Bayesian inference of the present embodiment, not only that only one value of this standard deviation is determined, but also that this standard deviation itself is estimated by distribution. “Average (standard deviation)” is an average value of distribution of this standard deviation. Accuracy of a prediction value can be evaluated by magnitude of the average (standard deviation). Further, as a result of Bayesian inference, a Rhat statistic is known as a statistic for evaluating whether or not estimation of a constructed regression model or a parameter constituting a regression model (for example, “inclination” if simple linear regression is considered) is appropriate. The Rhat statistic is also calculated for standard deviation of the prediction value described above, and this value is “Rhat (standard deviation)” in FIG. 3. The Rhat statistic is approximately one if estimation of the parameter is appropriate. If the Rhat statistic exceeds 1.1, it is generally evaluated that estimation that is performed is not appropriate. As described above, Rhat is a value obtained in a case where Bayesian inference is used as a statistical analysis algorithm, and a statistic called a determination coefficient is generally used as an evaluation index in a case where the least squares method is used as the statistical analysis algorithm. This statistic is one if variation of an actually-measured response can be completely explained by a prediction value obtained by a prediction model, and the larger the variation that cannot be explained is (the poorer the prediction performance of the prediction model is), the smaller the statistic is than one. A very poor model in which predication cannot be performed at all may take a negative value. As described above, the reliability information is obtained on the basis of degree of deviation between a model expression and a response in each of Bayesian inference and the least squares method.

Further, two upper and lower tables on the right side of the statistical information pane indicate statistical information of each term included in each of the RT prediction expression and the peak width prediction expression. Although calculation methods are different, an estimated value of each coefficient (each parameter) can be obtained as distribution in either Bayesian inference or the least squares method. The wider the distribution, the greater the uncertainty of the estimation. Here, various statistics related to information of this distribution are described. Specifically, an average value, a standard error, standard deviation, and the like of distribution of estimated values of coefficients are described. Here, 5%, 25%, and the like are called quantiles, and if the number of prediction values constituting distribution is 100, a quantile of 5% is a fifth prediction value when viewed from a smaller value, and a quantile of 25% is a 25th prediction value when viewed from a smaller value. In a case of the least squares method, this distribution is algorithmically symmetrical, but in a case of Bayesian inference, this distribution is not necessarily symmetrical. For this reason, not only spread of the distribution but also distortion of the distribution can be evaluated based on various pieces of quantile information (in general, it is considered that a poor model is estimated when distortion is significant). In this manner, it is possible to comprehensively determine whether estimation of each coefficient is appropriate using various types of information.

When the user refers to the statistical information pane as described above, it is possible not only to easily grasp information regarding appropriateness of a model expression on which a regression model is based and a fluctuation range of the regression model, but also to easily grasp a coefficient of each term constituting the regression model and a fluctuation range (reliability) of each coefficient. Further, by referring to a coefficient of each term of a regression model, it is possible to recognize degree of contribution of each factor to the regression model, that is, how much each factor affects a response, and it is easy to take measures such as reviewing the model expression in order to improve the reliability of the regression model. For example, in a case where a coefficient of a certain term is close to zero (for example, 0.0001 or the like), it means that the term hardly contributes to the regression model (response). However, since it also depends on the scale of original data, final determination needs to be performed comprehensively. For example, assume that a certain factor takes a value of about one digit, and magnitude of a coefficient associated with the factor is about three digits, while another factor takes a value of about three digits, and magnitude of a coefficient associated with the factor is about one digit. At this time, although magnitudes of the coefficients are different, magnitudes of the original factor are also different, and thus magnitudes of responses derived from the factors are about the same. As a method of determining whether or not contribution of a coefficient is small and whether or not it can be said that there is no problem even if the coefficient is removed from the model because the coefficient is small, in a case of the least squares method, a p value calculated in a case where a t-test is performed under the null hypothesis that “the value of the coefficient is zero” is used. Even if a value of a coefficient is close to zero, if the p value is equal to or less than a value determined in advance by an analyst (generally, 0.05 or less), it is determined that the coefficient has a large contribution to the model, and if the p value is equal to or more than a value determined in advance by the analyst, it is determined that the coefficient has a small contribution to the model.

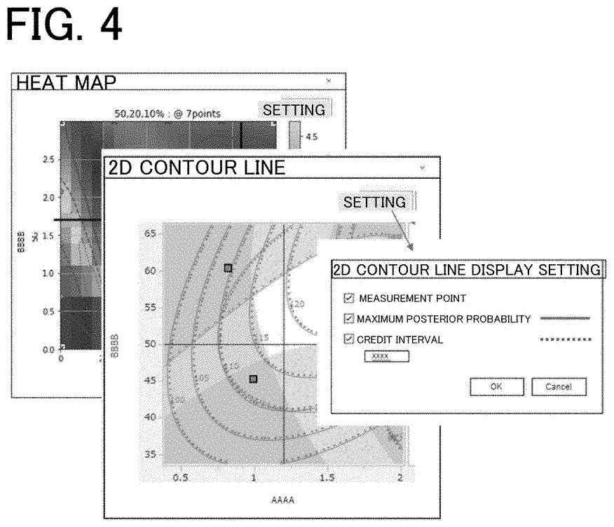

FIG. 4 illustrates an example of a two-dimensional graph. In this two-dimensional graph, a plurality of contour lines of specific response values are drawn on a two-dimensional graph in which factors (here, a factor on the vertical axis (displayed as AAAA) and another factor on the horizontal axis (displayed as BBBB)) are taken. Then, when the user presses “setting”, a display setting screen opens, and an element to be displayed in the two-dimensional graph can be selected. In this example, a measurement point, a maximum posterior probability, and a credit interval (%) can be selected as elements that can be displayed in the two-dimensional graph. The “credit interval (%)” indicates a fluctuation range of a contour line drawn in the two-dimensional graph. When the user selects the “credit interval (%)”, an error range of each contour line is displayed in the two-dimensional graph. A value of the credit interval (%) can be optionally set by the user. When the user sets a value of the credit interval, a width for holding the set reliability is displayed on the two-dimensional graph.

In a case where an area (experimental condition) in which a response of a certain value or more can be obtained is searched for using the statistical information pane and the two-dimensional graph as described above, if a value of standard deviation of a regression model is small, reliability of the regression model is high accordingly, and if an analysis condition of a coordinate point in the vicinity of a contour line in the two-dimensional graph is selected, there is a high possibility that a desired response value can be obtained. On the other hand, if a value of the standard deviation of the regression model is large, the reliability of the regression model is low accordingly, and it is necessary to select an analysis condition of a coordinate point sufficiently separated from a contour line in the two-dimensional graph toward a higher numerical value.

As described above, by using the statistical information pane indicating reliability information of a regression model in combination with the two-dimensional graph, it is possible to improve accuracy of the search for an analysis condition for obtaining a desired response value.

Note that the example described above is merely an example of an embodiment of the present invention. The embodiment of the data analysis system and the computer program according to the present invention is as described below.

An embodiment of a data analysis system according to the present invention includes a data storage part that stores a plurality of analysis results obtained by a plurality of analyses performed under a plurality of analysis conditions and a plurality of parameters included in the analysis conditions, wherein each analysis result is factor and each analysis condition is response, and the response and the factor are associated with each other, a data processor configured to perform operation using data stored in the data storage part, and a display electrically connected to the data processor. The data processor is configured to create a regression model indicating a relationship of a variable with the response, by determining coefficients of each of terms constituting a predetermined model expression, in which the factor is the variable, based on the model expression by using a predetermined statistical analysis algorithm, and the data processor is configured to create reliability information, which is able to be referred by a user on the display, by quantifying reliability of the regression model based on a relationship with the response.

In a first aspect of the embodiment, the reliability information includes an evaluation value of variation in the response to the regression model. With such an aspect, the user can easily grasp how much a fluctuation range of the regression model exists.

In the first aspect, the data processor may be configured to create a two-dimensional graph with the factor as a scale axis and draw a contour line of a specific response value in the two-dimensional graph, and to display the two-dimensional graph with the contour line on the display, and the data processor may be configured to display a fluctuation width of the contour line on the two-dimensional graph based on the evaluation value. In this manner, the user can easily recognize a fluctuation with of a contour line drawn in the two-dimensional graph displayed on the display.

Note that it may be configured such that the user can optionally set a fluctuation width (for example, a range in which the reliability is X%) to be displayed on the display.

In a second aspect of the embodiment, the data processor is configured to display information on degree of contribution to the regression model of each of the terms included in the model expression on the display together with the reliability information. According to such an aspect, the user can easily grasp how much each term (each factor) of the model expression affects a response. This second aspect can be combined with the first aspect.

In a third aspect of the embodiment, the reliability information includes appropriateness information of the model expression based on deviation degree of the regression model with respect to each of the responses. According to such an aspect, the user can easily determine whether or not a model expression based on a regression model is appropriate, and the model expression can be easily reviewed. This third aspect can be combined with the first aspect and/or the second aspect described above.

In a fourth aspect of the embodiment, the statistical analysis algorithm is Bayesian inference. Observed data does not necessarily reflects distribution of a population (population having an infinite sample size) well particularly in a case where a sample size is small. As described above, observation data essentially includes uncertainty. This uncertainty cannot be incorporated because the least squares method constructs a prediction model that better fits observed data. On the other hand, Bayesian inference has an advantage that it is possible to construct a prediction model incorporating this uncertainty to some extent by a framework of (1) handling a prediction value, various parameters, and the like as probability distribution, (2) introducing a concept of prior distribution, and the like. That is, predicted distribution of a response obtained by Bayesian inference and distribution of estimation of each coefficient are distributions in which this uncertainty is incorporated to some extent. As described above, a next action based on a result of the least squares method or Bayesian inference is to “determine an experimental condition for the next and subsequent times based on an analysis result”, and there is an advantage that a result by Bayesian inference incorporating data uncertainty is more suitable for achieving this purpose. This fourth aspect can be combined with the first aspect, the second aspect, and/or the third aspect described above.

In a fifth aspect of the embodiment, the statistical analysis algorithm is the least squares method. This fifth aspect can be combined with the first aspect, the second aspect, and/or the third aspect described above.

In a sixth aspect of the above embodiment, the model expression is configured so as to be able to be optionally set by a user, and the arithmetic processor is configured to create the regression model based on the model expression set by a user. According to such an aspect, degree of freedom in creating a regression model is improved, and a highly accurate regression model can be created. This sixth aspect can be combined with the first aspect, the second aspect, the third aspect, the fourth aspect, and/or the fifth aspect described above.

An embodiment of a computer program according to the present invention is configured to construct the above-described data analysis system by being introduced into a computer.

### DESCRIPTION OF REFERENCE SIGNS

1 data analysis system

2 data storage part

4 data processor

6 information input device

8 display

What is claimed is:

1. A data analysis system comprising:
a data storage part that stores a plurality of analysis results obtained by a plurality of analyses performed under a plurality of analysis conditions and a plurality of parameters included in the analysis conditions, wherein each analysis result is factor and each analysis condition is response, and the response and the factor are associated with each other;
a data processor configured to perform operation using data stored in the data storage part; and
a display electrically connected to the data processor, wherein
the data processor is configured to create a regression model indicating a relationship of a variable with the response, by determining coefficients of each of terms constituting a predetermined model expression, in which the factor is the variable, based on the model expression by using a predetermined statistical analysis algorithm, and
the data processor is configured to create reliability information, which is able to be referred by a user on the display, by quantifying reliability of the regression model based on a relationship with the response.

2. The data analysis system according to claim 1, wherein the reliability information includes an evaluation value of variation in the response to the regression model.

3. The data analysis system according to claim 2, wherein
the data processor is configured to create a two-dimensional graph with the factor as a scale axis and draw a contour line of a specific response value in the two-dimensional graph, and to display the two-dimensional graph with the contour line on the display, and
the data processor is configured to display a fluctuation width of the contour line on the two-dimensional graph based on the evaluation value.

4. The data analysis system according to claim 3, wherein the data processor is configured to allow a user to set the fluctuation width.

5. The data analysis system according to claim 1, wherein the data processor is configured to display information on degree of contribution to the regression model of each of the terms included in the model expression on the display together with the reliability information.

6. The data analysis system according to claim 1, wherein the reliability information includes validity information of the model expression based on deviation degree of the regression model with respect to each of the responses.

7. The data analysis system according to claim 1, wherein the statistical analysis algorithm is Bayesian inference.

8. The data analysis system according to claim 1, wherein the statistical analysis algorithm is a least squares method.

9. The data analysis system according to claim 1, wherein the model expression is configured so as to be able to be optionally set by a user, and the arithmetic processor is configured to create the regression model based on the model expression set by a user.

10. A computer program configured to construct the data analysis system according to claim 1 by being introduced into a computer.
